(19) United States
(12) Patent Application Publication
(10) Pub. No.: US 2024/0365454 A1
(43) Pub. Date: Oct. 31, 2024

(54) SYSTEM FOR GENERATING SITUATIONAL EFFECTS OF LIVE REAL-TIME SOUND RECEIVING AND APPLICATION METHOD THEREOF

(71) Applicant: FENG-CHOU LIN, New Taipei City (TW)

(72) Inventor: FENG-CHOU LIN, New Taipei City (TW)

(21) Appl. No.: 18/139,346

(22) Filed: Apr. 25, 2023

(51) Int. Cl. H05B 47/105; G06F 3/16; H04R 3/06; H04R 19/04; H05B 45/30

(52) U.S. Cl. CPC H05B 47/105; G06F 3/165; H04R 3/06; H04R 19/04; H05B 45/30; G08B 5/36; G08B 6/00; H04R 2201/003

(57) ABSTRACT

A system for generating situational effects of live real-time sound receiving and application method thereof, comprises: a situational effect controller provided with a plurality of control keys to control different situational effect items, and simultaneously outputs relative situational coding signals to a sound mixer device for mixing sound, then outputs a first audio signal from a live speaker, and a microphone sound receiving module of the situational effect generator can receive a first audio signal of a live environment, which is decoded and read through a situational decoding unit module and generate a corresponding first control signal and a second audio signal to trigger a situational action module to generate a relative situational action. In this way, it can be used in various parties, concerts, movie theaters, or nightclubs, etc., to capture live environmental audio.

### BACKGROUND OF THE INVENTION

### Field of the Invention

The present invention relates to the technical field of a live situational equipment, especially a system for generating situational effects of live real-time sound receiving and application method thereof.

### The Prior Arts

With the advancement of science and technology, when people watch movies, play electronic sports (e-sports) games, or participate in live concerts, they can provide rich images and sound and light effects through large displays and speakers, so that the audience or players can experience visual and auditory effects to obtain a pleasing feeling, and the effect of regulating the body and mind can be fully achieved. Even through a special device, people can feel the frequency vibration of the music and resonate with the music during the process of listening to the music.

The more advanced design can send corresponding a synchronous somatosensory vibration through the tactile transducer to enhance listening to a stereo music, watching movies, or engaging in electronic games, you can enjoy immersive live effects, and then achieve immersive somatosensory enjoyment.

More advanced design, in concerts or nightclubs, free hand-held light sticks will also be gifted, allowing the audience to wave and swing with the rhythm of the music while enjoying the song and dance performance, creating cool stage sound and light effect, in order to enhance the audience's sense of participation to express their emotions, and make the atmosphere of dynamic singing and dancing more enthusiastic.

The prior art is that the light interaction method of the audience on the spot is mainly to turn on the light of the mobile phone and shake it, or shake it with an LED light stick. The more advanced method is to control the lighting through on-site lighting, and use a special control device to achieve lighting control effects through wireless transmission or wired audio signals, to achieve lighting control effect with separate area setting. However, the control device is expensive, and the control methods used are complicated and only a few lighting mode can be set, when playing live music at the concert and taking into account the control of the auditorium light signal, that is really complicated, and the audience must cooperate in a fixed position, and cannot switch the light color arbitrarily, so as to ensure that each area receives the correct frequency, to emit the desired lighting effect.

In short, the prior art on-site interactive lighting control is currently not well-equipped, and it cannot be combined more effectively with the current more advanced immersive somatosensory, so further improvement is necessary.

### SUMMARY OF THE INVENTION

In view of this, the main purpose of the present invention is to provide a system for generating situational effects of live real-time sound receiving, comprises: a situational effect controller and at least one situational effect generator; wherein

The situational effect controller is provided with an operation interface, and the operation interface is provided with a plurality of control keys, each of the plurality of control keys controls a situational effect item correspondingly, and corresponds to a situational coding signal simultaneously, when one of the plurality of control keys is activated, the situational effect controller outputs one of the situational coding signals correspondingly to a sound mixer device for mixing sound with the live audio source, then outputs a first audio signal from a live speaker:

Wherein the situational coding signal is composed of multiple frequencies, the situational coding signal has at least two or more different frequency bands, the frequency bands are separated by a time interval, and the situational coding signal is coded by different gain values; and

The front end of the situational effect generator has a microphone sound receiving module to receive the first audio signal in a live environment sound, a situational decoding unit module is used for a signal amplification, a filtering, an analog to digital conversion (ADC) and a calculation comparison to read the situational coding signal, and generate a first control signal and a second audio signal which through a corresponding data of a built-in memory unit to trigger a situational action module to generate a relative situational action, wherein the situational action module is composed of one type of an LED lighting lamp group, a somatosensory vibrator, or a combination of both thereof.

A preferred embodiment, wherein the situational effect generator interpretes (decodes and reads) an ARGB (ADDRESSABLE RGB) LED control command corresponding to a characteristic waveform signal with a preset code to generate the first control signal to drive an ARGB (ADDRESSABLE RGB) light bar of the LED lighting lamp group to generate a corresponding LED light flashing mode, simultaneously, the second audio signal generated by the situational effect generator is transformed into the corresponding a music low-frequency effect through a operational amplifier, or a multiple frequencies of a special sound effects in movies and games such as bomb shell blasting, a vibration waveform thereof is used to trigger a somatosensory tactile transducer to generate a corresponding somatosensory vibration.

A preferred embodiment, wherein the microphone sound receiving module is composed of a single microelectric machanic system (MEMS) microphone, multiple microelectric machanic system (MEMS) microphones, or multiple array microelectric machanic system (MEMS) microphones. However, there are not restrictions on foregoing in reality.

A preferred embodiment, a signal of each microelectric machanic system (MEMS) microphone is amplified and then connected to the situation decoding unit module, and the situational decoding unit module at least comprises an operational amplifier, a low pass filter, and an analog to digital converter (ADC) to I²S (Integrated Interchip Sound) which are connected in sequence, then pass through a DSP (Digital Signal Processor) for waveform calculation and comparison, but it is not limited to this.

Compared with the prior art technology, the present invention presents a system for generating situational effects of live real-time sound receiving and application method thereof, the overall effective design is simple, the live instant response effect is very good, and the lighting control command signal is transmitted through the 360 degrees space of the live speaker and capture the live music signal to achieve the features of the one-to-many broadcast, no interference, no delay, which can be widely used in various parties, concerts, movie theaters, or nightclubs, etc., effectively transmit LED lighting effects and immersive experience to feel the somatosensory vibration and reach the highest level of immersive entertainment.

### BRIEF DESCRIPTION OF THE DRAWINGS

FIG. 1 is a configuration diagram of the system of the present invention.

FIG. 2 is a schematic diagram of the situational coding signal of the present invention.

FIG. 3 is a detailed block diagram of the system of the present invention.

FIG. 4 is a schematic diagram of the combination of the LED lighting lamp group and the somatosensory vibrator of the present invention.

FIG. 5 is a detailed block diagram of FIG. 4 of the present invention.

FIG. 6 is a flow chart of the method of the present invention.

### EMBODIMENT

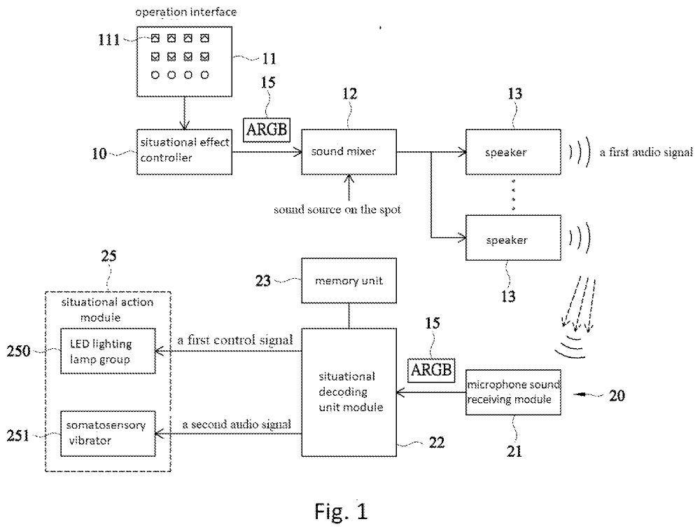

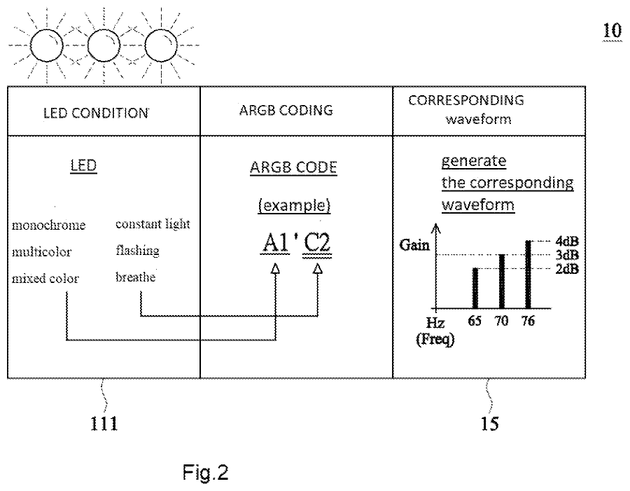

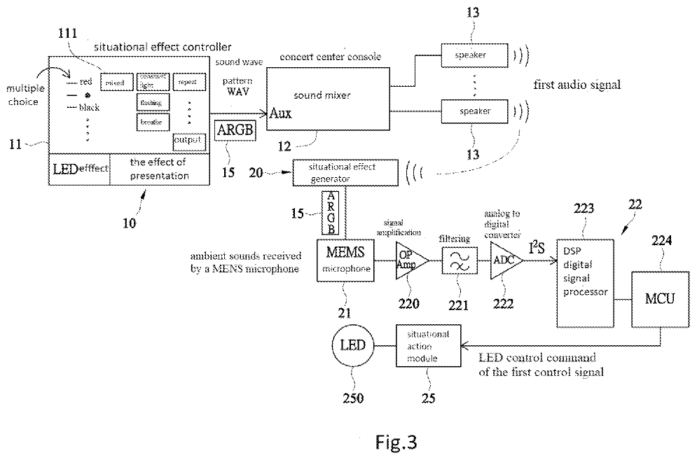

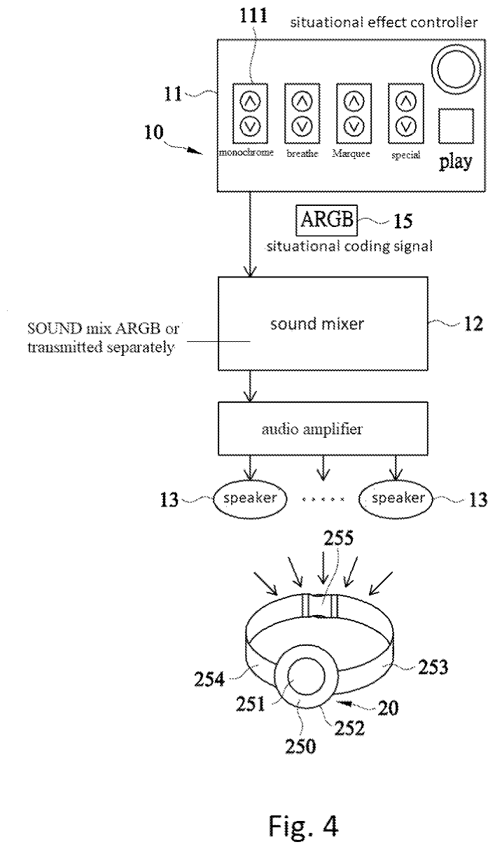

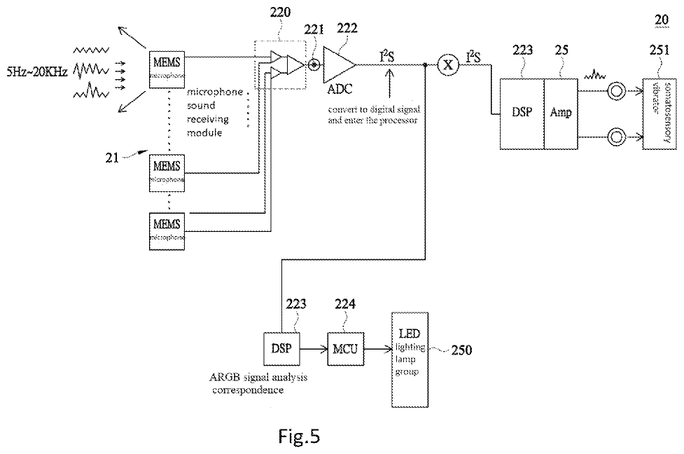

For understanding conveniently the content of the present invention and the effect that can be achieved, the specific embodiments are listed in conjunction with the drawings, and the details are as follows: please refer to shown in FIG. 1 to FIG. 5. A system for generating situational effects of live real-time sound receiving mainly comprises: a situational effect controller 10 and at least one situational effect generator 20; wherein

The situational effect controller 10 is provided with an operation interface 11, and the operation interface 11 is provided with a plurality of control keys 111, each of the plurality of control keys 111 controls a situational effect item correspondingly, and corresponds to a situational coding signal 15 simultaneously, when one of the plurality of control keys 111 is activated, the situational effect controller 10 outputs one of the situational coding signals 15 correspondingly to a sound mixer device 12 for mixing sound with the live audio source, then outputs a first audio signal from a live speaker 13.

Wherein the situational coding signal 15 is composed of multiple frequencies, the situational coding signal has at least two or more different frequency bands, the frequency bands are separated by a time interval, and the situational coding signal 15 is coded by different gain values: A preferred embodiment, which is used a 100 Hz 1V sine wave to generate a 120 Hz 0.5V sine wave at an interval of 100 ms, assuming that this audio sequence represents turning the ARGB (ADDRESSABLE RGB) light bar into 5 specific colors in a sequential marquee manner, wherein the situational coding signal is a plurality of frequency sinusoidal waves with a time interval between 100 mm and 300 mm, but it is not limited to this actually. And in order to avoid conflict with the live sound source and cause failure, if necessary, an equal interval of a blank time tag between 100 mm and 500 mm which is provided before and after the plurality of frequency sinusoidal waves of the situational coding signal 15, but it is not limited to this in practice; and

The front end of the situational effect generator 20 has a microphone sound receiving module 21 to receive the first audio signal in a live environment sound, a situational decoding unit module is used for a signal amplification, a filtering, an analog to digital conversion (ADC) and a calculation comparison to read the situational coding signal 15, and generate a first control signal and a second audio signal which through a corresponding data of a built-in memory unit 23 to trigger a situational action module 25 to generate a relative situational action, wherein the situational action module 25 is composed of one type of an LED lighting lamp group 250, a somatosensory vibrator 251, or a combination of both thereof.

A preferred embodiment, wherein the situational effect generator 20 interpretes (decodes and reads) an ARGB (ADDRESSABLE RGB) LED control command corresponding to a characteristic waveform signal with a preset code to generate the first control signal to drive an ARGB (ADDRESSABLE RGB) light bar of the LED lighting lamp group 250 to generate a corresponding LED light flashing mode, simultaneously, the second audio signal generated by the situational effect generator 20 is transformed into the corresponding a music low-frequency effect through a operational amplifier 220, or a multiple frequencies of a special sound effects in movies and games such as a bomb shell blasting, a vibration waveform thereof is used to trigger a somatosensory tactile transducer to generate a corresponding somatosensory vibration.

A preferred embodiment, wherein the microphone sound receiving module 21 is composed of a single microelectric machanic system (MEMS) microphone, multiple microelectric machanic system (MEMS) microphones, or multiple array microelectric machanic system (MEMS) microphones, a signal of each microelectric machanic system (MEMS) microphone is amplified and then connected to the situation decoding unit module 22, but it is not limited to this actually.

A preferred embodiment, wherein the situational decoding unit module 22 at least comprises an operational amplifier 220, a low pass filter, and an analog to digital converter (ADC) 222 to a I²S (Integrated Interchip Sound) which are connected in sequence, then pass through a DSP (Digital Signal Processor) 223 for a waveform calculation and comparison, but it is not limited to this actually.

A preferred embodiment, the LED light-emitting lamp group 250 is one of the following, comprises a ring type, a strip type or an array type, but it is not limited to this actually.

A preferred embodiment, wherein the somatosensory vibrator 251 has a body, which is composed of an upper cover and a lower cover, and a main control circuit board and a sensing transmission component (not shown in the above figure) which are arranged in the inner space, the main control circuit board receives the second audio signal from the situational decoding unit module 22, converts the second audio signal into a somatosensory vibration waveform and transmits the somatosensory vibration waveform to the sensing transmission component, but it is not limited to this actually.

A preferred embodiment, wherein the body 252 is further provided with a first belt body 253 on one side of the body 252, and a second belt body 254 is provided on the other side of the body 252, and a movable end of the first belt 253 and the second belt body 254 which are connected with a buckle 255, but is not limited to this actually.

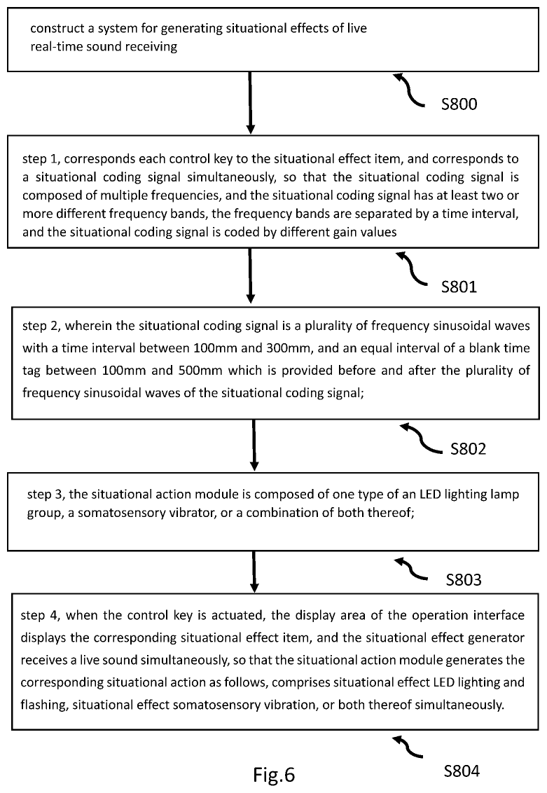

More specifically and further disclosed, as shown in FIG. 1 to FIG. 6, an application method of a system for generating situational effects of live real-time sound receiving of the present invention, comprises:

S800, at first, construct a system for generating situational effects of live real-time sound receiving, which has a situational effect controller 10 and a situational effect generator 20; wherein

The situational effect controller 10 is provided with an operation interface 11, and the operation interface 11 is provided with a plurality of control keys 111 to control different situational effect items, and the situational effect controller 10 outputs a corresponding situational coding signal 15 to a sound mixer device 12 for mixing sound with a live audio source, and outputs a first audio signal from a live speaker 13; and

The front end of the situational effect generator has a microphone sound receiving module 21 to receive the first audio signal in a live environment sound, and a situational decoding unit module 22 is used for a signal amplification, a filtering, an analog to digital conversion (ADC) and a calculation comparison to read a situational coding signal 15, and generate a first control signal and a second audio signal through a corresponding data of a built-in memory unit 23 to trigger a situational action module 25 to generate a relative situation action, and perform the following method steps:

S801, step 1, corresponds each control key 111 to the situational effect item, and corresponds to a situational coding signal 15 simultaneously, so that the situational coding signal 15 is composed of multiple frequencies, and the situational coding signal has at least two or more different frequency bands, the frequency bands are separated by a time interval, and the situational coding signal is coded by different gain values:

S802, step 2, wherein the situational coding signal 15 is a plurality of frequency sinusoidal waves with a time interval between 100 mm and 300 ms, and an equal interval of a blank time tag between 100 mm and 500 ms which is provided before and after the plurality of frequency sinusoidal waves of the situational coding signal 15:

S803, step 3, the situational action module 25 is composed of one type of an LED lighting lamp group 250, a somatosensory vibrator 251, or a combination of both thereof; and

S804, step 4, when the control key 111 is actuated, the display area of the operation interface 11 displays the corresponding situational effect item, and the situational effect generator 20 receives a live sound simultaneously, so that the situational action module 25 generates the corresponding situational action as follows, comprises situational effect LED lighting and flashing, situational effect somatosensory vibration, or both thereof simultaneously.

In this way, The system for generating situational effects of live real-time sound receiving of the present invention, the lighting control command signal is transmitted through the 360 degrees space of the live speaker 13 and capture the live music signal to achieve the features of the one-to-many broadcast, no interference, no delay, which can be widely used in various parties, concerts, movie theaters, or nightclubs, etc., effectively transmit LED lighting effects and immersive experience to feel the somatosensory vibration and reach the highest level of immersive entertainment.

During application, as shown in FIG. 1 to FIG. 6, On the operation interface 11 of the situational effect controller 10 of the present invention, there are a variety of control keys 111 to provide single-select or multi-select selection items of different lights to control the LED to generate a monochrome constant light or flashing, or a multi-color constant light flashing, or a mixed color, a breathing color and other different types, to combine lights with different environments, dynamic effects can also be used in the way of marquees to make each area lights running.

In this way, when the color of the control key 111 is pressed, there will be a display area corresponding to the color of the selected LED and its dynamic preview display effects that are displayed on the operation interface 11. The specific changeable color combination of the selected light number automatically corresponds to generate an ARGB (ADDRESSABLE RGB) sound wave code of the exclusive situational coding signal 15 of the present invention, which can be selected from two frequency bands or more than three frequency bands, and utilizes each frequency band to be continuous without interval, or its interval between each other is difference in size and gain, such as 2 dB, 3 dB, 4 dB. It is used as a coding method to generate a sinusoidal waveform, the best time interval is around 200 mini seconds, but it is not limited to this.

It cannot be ignored that each music has a certain range. For example, a certain music contains 80 Hz. When the situational coding signal 15 with the same 80 Hz is arranged therein, the sound of the lighting control command of the situational coding signal 15 can be effectively merged together by the live music, and will not be covered by the live music to be invalid. In addition to using the foregoing special multi frequency situational coding signal 15 control command, the blank time tag can also be arranged before and after the situational coding signal 15 like 100 ms., but it is not limited to this. In this way, it can be ensured that the commands of the situational coding signal 15 are compatible and combined with the live music and will not be covered, and simultaneously can be correctly interpreted (decodes and reads) to achieve the purpose of the remote real-time control of the light signal.

The situational coding signal 15 forming the ARGB (ADDRESSABLE RGB) sound waveform can be a WAV file, but it is not limited to this actually. In this way, the sound can be released into the first audio signal through the sound mixer 12 of center console of the concert and the speaker 13 on the spot. When the situational effect generator 20 at the receiving end on the spot that receives the first audio signal, it will perform a fast Fourier series conversion according to the continuous waveform and perform a real-time comparison. When the comparison is found any item that is the serial database contains the preset ARGB (ADDRESSABLE RGB) waveform. The first control signal will be generated corresponding to drive the situational action module 25, so as to generate the corresponding ARGB (ADDRESSABLE RGB) LED lighting effect.

Specifically, when the ARGB (ADDRESSABLE RGB) code sound wave waveform of the situation encoding signal 15 is played out by the loudspeaker 13 on the spot, the situational effect generator 20 on the spot can receive the specific audio through the microphone sound receiving module 21. Wherein the microelectric machanic system (MEMS) microphone using the semiconductor process has an excellent sound receiving frequency effect, the lowest receiving frequency is 6 Hz, and it can play a wide range sound receiving effect. When it is applied, it can be used as a single microphone for sound receiving, or it can be used as a multiple array microphone that the peripheral sound can be effectively collected, then the audio will be filtered through the audio amplification and filtering circuit to produce an effective frequency range, then converted into an I²S digital signal through the ADC analog to digital converter 222, then entered into the DSP digital signal processor 223 to make a spectrum comparison, and use the MCU (micro control unit) 224 inside the signal processor to continuously execute the signal comparison operation. When it is found that there is a leading indicator in the audio data sequence and is consistent with a certain lighting control command data string, a first control signal of a set of LED control commands will be generated internally. The control signal is sent to the LED lighting lamp group 250 to activate the ARGB (ADDRESSABLE RGB) light bar controller and emit corresponding ARGB (ADDRESSABLE RGB) LED lights.

Through this effective control method, each situational coding signal 15 has an LED control command, and the system can freely make various special situations on the spot, whether it is monochromatic, mixed, or special flash twinkle effect, so that the situation coded signal 15 can be effectively mixed with the live performance sound through the live sound mixer 12, but it can also be distinguished from the live music, whether it is singing, played alone or mixed in the music, it can be perfectly achieved to control the emission purpose, let the situational effect generator 20 as the receiving end that emit different corresponding colors accordingly.

For example, the host at the concert said: Let us pay tribute to the Ukrainian people together now. After a control key 111 is pressed down, the signal is decomposed and recognized at once. For example: code A1+C2, the sound is mixed therewith, then spread to every corner. At this time, audiences wearing devices with situational effect generator 20 will display the colors of the Ukrainian national flag on the upper blue and lower yellow of the ARGB (ADDRESSABLE RGB) light bar on the LED lighting lamp group 250 on the device, which will instantly drive the interactive atmosphere on the spot. But it is not limited to this, and it can also be used to pay tribute to the national flags of different countries for interactive display. Or in concerts or nightclubs, all audiences are equipped with situational effect generators 20, and can receive the control of situational coding signals 15 transmitted from the control room on the spot at any time, and the situational effect generators 20 of all audiences will instantly present the same luminescence effect, along with the rhythm of the music, it shows different lighting changes of the corresponding environment atmosphere, and then presents a shocking visual effect.

In addition, through the microphone receives sound on the spot, the bass range of live music can be converted into corresponding shock waves, and the shock waves can be transmitted to the human body through the somatosensory vibrator 251. The two parts of LED lighting effect and somatosensory vibration which can be combined or implemented separately to apply to entertainment venues such as concerts, movie theaters, or nightclubs. The situational effect generator 20 of the present invention is applied as a wearable device, so that the user is not limited by wired or Bluetooth wireless transmission, and can receive the surrounding environment in real time as long as he is in a concert, a movie theater, a nightclub or any place with music, this ARGB (ADDRESSABLE RGB) LED lighting effect combined with situational somatosensory dual effects can enable users to obtain the best immersive experience.

In summary, the novelty and practicality of the present invention fully meets the requirements of the patent, and an application for a patent for invention is proposed. But the foregoing is only a preferred embodiment of the present invention, and should not limit the scope of the present invention: so all equivalent changes and modifications made according to the patent scope of the present invention and the contents of the invention specification should be within the scope covered by the patent of the present invention.

What is claimed is:

1. A system for generating situational effects of live real-time sound receiving, comprising: a situational effect controller and at least one situational effect generator:
the situational effect controller is provided with an operation interface, and the operation interface is provided with a plurality of control keys, each of the plurality of control keys controls a situational effect item correspondingly, and corresponds to a situational coding signal simultaneously, when one of the plurality of control keys is activated, the situational effect controller outputs one of the situational coding signals correspondingly to a sound mixer device for mixing sound with the live audio source, then outputs a first audio signal from a live speaker;
wherein the situational coding signal is composed of multiple frequencies, the situational coding signal has at least two or more different frequency bands, the frequency bands are separated by a time interval, and the situational coding signal is coded by different gain values; and
the front end of the situational effect generator has a microphone sound receiving module to receive the first audio signal in a live environment sound, a situational decoding unit module is used for a signal amplification, a filtering, an analog to digital conversion (ADC) and a calculation comparison to read the situational coding signal, and generate a first control signal and a second audio signal which through a corresponding data of a built-in memory unit to trigger a situational action module to generate a relative situational action, wherein the situational action module is composed of one type of an LED lighting lamp group, a somatosensory vibrator, or a combination of both thereof.

2. The system for generating situational effects of live real-time sound receiving as claimed in claim 1, wherein the situational coding signal is a plurality of frequency sinusoidal waves with a time interval between 100 ms and 300 ms.

3. The system for generating situational effects of live real-time sound receiving as claimed in claim 1, wherein an equal interval of a blank time tag between 100 ms and 500 ms which is provided before and after the plurality of frequency sinusoidal waves of the situational coding signal.

4. The system for generating situational effects of live real-time sound receiving as claimed in claim 1, wherein the microphone sound receiving module is composed of a single microelectric machanic system (MEMS) microphone, multiple microelectric machanic system (MEMS) microphones, or multiple array microelectric machanic system (MEMS) microphones, a signal of each microelectric machanic system (MEMS) microphone is amplified and then connected to the situation decoding unit module.

5. The system for generating situational effects of live real-time sound receiving as claimed in claim 1, wherein the situational decoding unit module at least comprises an operational amplifier, a low pass filter, and an analog to digital converter (ADC) to I²S (Integrated Interchip Sound) which are connected in sequence, then pass through a DSP (Digital Signal Processor) for waveform calculation and comparison.

6. The system for generating situational effects of live real-time sound receiving as claimed in claim 1, wherein the somatosensory vibrator has a body, which is composed of an upper cover and a lower cover, and a main control circuit board and a sensing transmission component smits the somatosensory vibration waveform to the sensing transmission component which are arranged in the inner space, the main control circuit board receives the second audio signal from the situational decoding unit module, converts the second audio signal into a somatosensory vibration waveform and transmits the somatosensory vibration waveform to the sensing transmission component and transmits the somatosensory vibration waveform to the sensing transmission component.

7. The system for generating situational effects of live real-time sound receiving as claimed in claim 1, wherein the body is further provided with a first belt body on one side of the body, and a second belt body is provided on the other side of the body, and a movable end of the first belt and the second belt body which are connected with a buckle.

8. An application method of a system for generating situational effects of live real-time sound receiving, comprising:
at first, construct a system for generating situational effects of live real-time sound receiving, which has a situational effect controller and a situational effect generator: wherein
the situational effect controller is provided with an operation interface, and the operation interface is provided with a plurality of control keys to control different situational effect items, and the situational effect controller outputs a corresponding situational coding signal to a sound mixer device for mixing sound with a live audio source, and outputs a first audio signal from a live speaker; and
the front end of the situational effect generator has a microphone sound receiving module to receive the first audio signal in a live environment sound, and a situational decoding unit module is used for a signal amplification, a filtering, an analog to digital conversion (ADC) and a calculation comparison to read a situational coding signal, and generate a first control signal and a second audio signal through a corresponding data of a built-in memory unit to trigger a situational action module to generate a relative situation action, and perform the following method steps:
step 1, corresponds each control key to the situational effect item, and corresponds to a situational coding signal simultaneously, so that the situational coding signal is composed of multiple frequencies, and the situational coding signal has at least two or more different frequency bands, the frequency bands are separated by a time interval, and the situational coding signal is coded by different gain values;
step 2, wherein the situational coding signal is a plurality of frequency sinusoidal waves with a time interval between 100 ms and 300 ms, and an equal interval of a blank time tag between 100 mm and 500 ms which is provided before and after the plurality of frequency sinusoidal waves of the situational coding signal;
step 3, the situational action module is composed of one type of an LED lighting lamp group, a somatosensory vibrator, or a combination of both thereof; and
step 4, when the control key is actuated, the display area of the operation interface displays the corresponding situational effect item, and the situational effect generator receives a live sound simultaneously, so that the situational action module generates the corresponding situational action as follows, comprises situational effect LED lighting and flashing, situational effect somatosensory vibration, or both thereof simultaneously.

9. The application method of a system for generating situational effects of live real-time sound receiving as claimed in claim 8, wherein the situational effect generator interpretes (decodes and reads) an ARGB (ADDRESSABLE RGB) LED control command corresponding to a characteristic waveform signal with a preset code to generate the first control signal to drive an ARGB (ADDRESSABLE RGB) light bar of the LED lighting lamp group to generate a corresponding LED light flashing mode, simultaneously, the second audio signal generated by the situational effect generator is transformed into the corresponding a music low-frequency effect through a operational amplifier, or a multiple frequencies of a special sound effects in movies and games such as bomb shell blasting, a vibration waveform thereof is used to trigger a somatosensory tactile transducer to generate a corresponding somatosensory vibration.

10. An application method of a system for generating situational effects of live real-time sound receiving as claimed in claim 8, wherein the microphone sound receiving module is composed of a single microelectric machanic system (MEMS) microphone, multiple microelectric machanic system (MEMS) microphones, or multiple array microelectric machanic (MEMS) microphones, wherein a signal of each microelectric machanic (MEMS) microphone is amplified and then connected to the situational decoding unit module, the situational decoding unit module at least comprises an operational amplifier, a low-pass filter, an analog to digital converter (ADC) to convert to I²S (Integrated Interchip Sound) which are connected in sequence, and then through a DSP (Digital Signal Processor) for waveform calculation and comparison.
